(19) United States
(12) Patent Application Publication
(10) Pub. No.: US 2006/0024024 A1
(43) Pub. Date: Feb. 2, 2006

(54) PLAYBACK DEVICE CAPABLE OF SYNCHRONIZING PLAYBACK OF VIDEO SIGNAL PORTION AND AUDIO SIGNAL PORTION OF AV SIGNAL AND METHOD THEREOF

(76) Inventors: Cheng-Che Chen, Kao-Hsiung City (TW); Chih-Chiang Chuang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/160,828

(22) Filed: Jul. 12, 2005

(30) Foreign Application Priority Data
Jul. 27, 2004 (TW) 093122444
Mar. 4, 2005 (TW) 094106606

(51) Int. Cl. H04N 5/783

(52) U.S. Cl. 386/69; 386/70

(57) ABSTRACT

A playback device for playing an audio-visual (AV) signal. The AV signal includes a video signal portion and an audio signal portion. The playback device includes: a reference time point retrieving unit for retrieving playback timing of the audio signal portion to be a reference time point; and an AV synchronization control unit for controlling playback of the video signal portion according to the reference time point.

### BACKGROUND

The present invention relates to a method and a playback device for playing back audio-visual (AV) data, and more specifically to a method and a playback device that synchronize playback of audio-visual data utilizing time stamps generated from audio data.

Technology derives from humanity. Advancements in technology originate from the expectation of a better life for human beings. The storage and playback of audio-visual data are good examples of technological progress for the benefit of people. If an audio-visual clip (i.e., a segment of AV content) can be recorded using a larger file volume, then the quality of the clip will be finer; more closely matching human requirements. Because of the high-speed technological progress of storage media, the size of audio-visual files is no longer the kernel of the problem. The improvement of the playing quality of audio-visual information becomes the main subject for all R&D personnel. In addition to the errors that may occur when storing the audio-visual files, the asynchronous playback of video and audio data easily causes viewers to become discontented. In other words, an asynchronous playback of the visual data and the audio data while playing the audio-visual files is very annoying to viewers. Therefore, a good audio-visual decoder will become more and more important in the future entertainment market.

Please refer to FIG. 1. FIG. 1 shows a block diagram of the audio-visual playback device 100 according to the related art. The audio-visual playback device 100 is used to drive an external display device 112 (e.g., a monitor) for displaying video/images and an external loudspeaker 114 to output audio. As shown in FIG. 1, the audio-visual playback device 100 comprises an audio-visual separation unit 102, a video decoding unit 104, an audio decoding unit 106, a video driving unit 108, an audio driving unit 110, an audio data counting unit 116, a clock generator 118, a visual data counting unit 120, a delay detection unit 122, and a frame control unit 124. The operation of the audio-visual playback device 100 is as follows:

At first, an AV_data is input to the audio-visual separation unit 102, and then the audio-visual separation unit 102 divides the AV_data into a video signal portion DATA_V and an audio signal portion DATA_A, where the video signal portion DATA_V is transmitted to the video decoding unit 104 and the audio signal portion DATA_A is transmitted to the audio decoding unit 106. The video signal portion DATA_V comprises a plurality of image frames, and the audio signal portion DATA_A comprises a plurality of audio frames, wherein each of the audio frames comprises a plurality of f audio samples. Next, the plurality of image frames will be transmitted one by one into the video decoding unit 104 for decoding and the video decoding unit 104 will sequentially output the completely decoded image frames to the video driving unit 108. Next, the video driving unit 108 drives the display device 112 to sequentially display the image frames. Furthermore, the plurality of audio frames will be transmitted to the audio decoding unit 106 one by one for decoding and the audio decoding unit 106 will output the decoded audio frames sequentially to the audio driving unit 110. Next, the audio driving unit 110 will sequentially output the audio samples to the loudspeaker 114. As mentioned above, audio and image frames are played separately. However, the time required for decoding each frame of the DATA_A is approximately the same, while the time required for decoding each frame of the DATA_V often varies dramatically. When the operation capability of the hardware is not powerful enough or interfered by other factors, it is possible that decoding of a video frame will require more time than is expected. This may cause the mismatch of audio and visual data during playback, thus reducing the playing quality.

To solve this problem, the audio-visual playback device 100 of the related art provides a method to compensate the asynchronous playback issue of the audio and visual data. At first, the audio data counting unit 116 counts the audio samples in the audio driving unit 106 so as to obtain the corresponding serial number of the image frame that should be displayed in synchronization with the audio samples to be played in the speaker, 114, i.e. a first number. While doing this, the visual data counting unit 120 also counts the serial number of the image frame which is completely decoded and is going to be played, i.e., a second number. Next, the delay detection unit 122 will compare the first number and the second number. If they are the same, which means the image frame that should be played and the image frame that is now being played are the same, there is no need to perform any adjustment for the image frame playing. If the first number is smaller than the second number, which means the speed of the image playing is faster than the speed of the audio playing, then the frame control unit 124 will send a control signal Sc to the video decoding unit 104 for delaying/decreasing the decoding speed of the DATA_V. On the other hand, if the first number is larger than the second number, which means the playing speed of the image is slower than the playing speed of the audio, the frame control unit 124 will send the control signal Sc to the video decoding unit 104 for controlling the video decoding unit 104 to skip the decoding of one or more image frames.

However, the synchronization control method adjusts the playing speed of the image frames only when observing the asynchronous playback of the video and audio data currently being played. Namely, in the prior art synchronization control method, adjustment to the mismatch (i.e. asynchronous playback) as described above occurs after the error (i.e. asynchronous playback) has been detected. Meanwhile, the asynchronization of the audio and video playback of the AV_DATA is already apparent to a user or viewer. Thus, the audio-visual playback device 100 of the related art can only redeem the already happened AV asynchronization, but it cannot prevent asynchronization from occurrence in advance. Improving the quality of the AV playing in this fashion is not efficient.

### SUMMARY

It is therefore one of the objectives of the claimed invention to provide an audio-visual (AV) synchronization playback device and a related method to avoid the asynchronization between audio and visual data playback, and solve the aforementioned problem.

According to one embodiment of the claimed invention, a playback device for playing an AV signal is disclosed. The AV signal comprises a video signal portion and an audio signal portion. The playback device comprises: a reference time point retrieving unit for retrieving playback timing information of the audio signal portion to be a reference time point; and an AV synchronization control unit for controlling playback of the video signal portion according to the reference time point.

According to the embodiment of the claimed invention, a method for playing an AV signal is further disclosed. The AV signal comprises a video signal portion and an audio signal portion. The method comprises: retrieving playback timing information of the audio signal portion to be a reference time point; and controlling playback of the video signal portion according to the reference time point.

The AV synchronization playback device and the related method of the present invention perform adjustment before asynchronization of the audio and visual data occur, and therefore can efficiently improve the playing quality of the audio-visual playback.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an audio-visual (AV) playback device according to the related art.

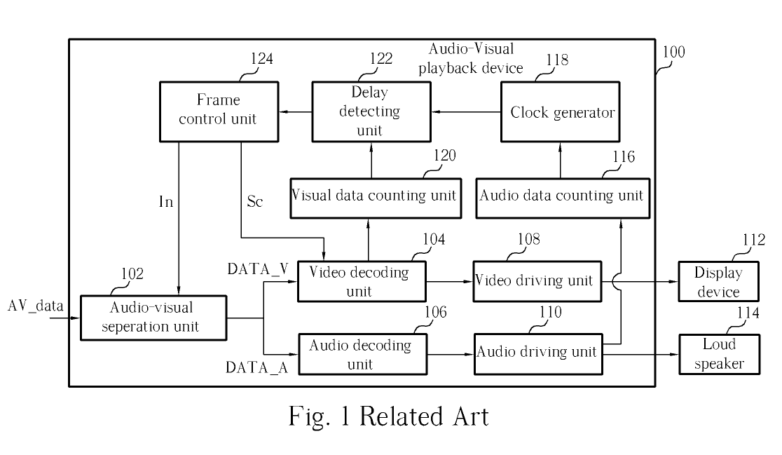

FIG. 2 is a block diagram of an AV synchronization playback device according to a first embodiment of the present invention.

FIG. 3 is a block diagram of an AV synchronization playback device according to a second embodiment of the present invention.

### DETAILED DESCRIPTION

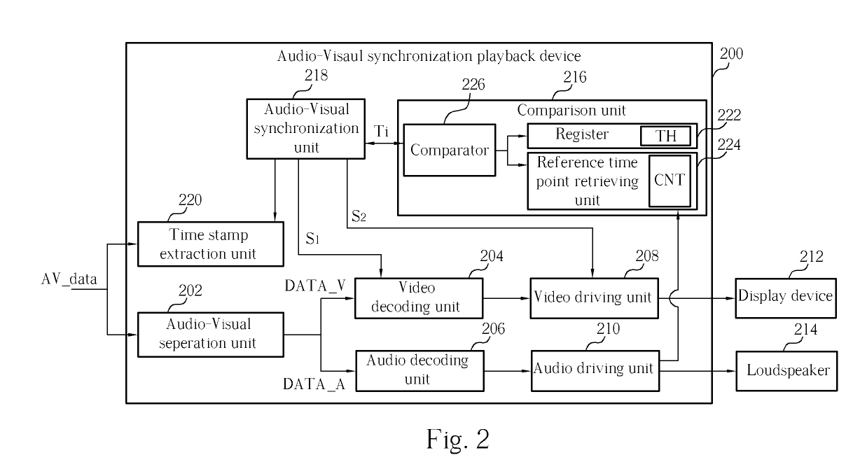

Please refer to FIG. 2. FIG. 2 is a block diagram of an audio-visual (AV) synchronization playback device 200 according to a first embodiment of the present invention. The AV synchronization playback device 200 is utilized for driving an external display device 212 (e.g., a monitor) to display video/images and to drive an external loudspeaker 214 to output sound. In this embodiment, the AV synchronization playback device 200 comprises an AV separation unit 202, a video decoding unit 204, an audio decoding unit 206, a video driving unit 208, an audio driving unit 210, a comparison unit 216, an AV synchronization control unit 218, and a time stamp extraction unit 220. Moreover, in this embodiment, the comparison unit 216 comprises a register 222, a reference time point retrieving unit 224, and a comparator 226, where the reference time point retrieving unit 224 is a counter in this embodiment. The functions of these components of the AV synchronization playback device 200 are described as follows.

The AV separation unit 202 is utilized for separating the inputted AV_data into an image signal portion DATA_V and an audio signal portion DATA_A, where the image signal portion DATA_V comprises a plurality of image frames and the audio signal portion DATA_A comprises a plurality of audio frames. Each of the audio frames comprises a plurality of audio samples. Next, the plurality of the image frames will be transmitted one-by-one into the video decoding unit 204 for decoding, and the video decoding unit 204 will sequentially output the decoded image frames to the video driving unit 208. Next, the video driving unit 208 drives the display device 212 to sequentially display the image frames. Additionally, the plurality of the audio frames will be transmitted one-by-one to the audio decoding unit 206 for decoding, and the audio decoding unit 206 will sequentially transmit the decoded audio frames to the audio driving unit 210. Next, the audio driving unit 210 sequentially outputs the received audio samples to the loudspeaker 214. As described above, the image frames and audio frames are decoded separately.

In this embodiment, the time stamp extraction unit 220 is used for retrieving the time stamp of each of the image frames, wherein each of the time stamps comprises/records the playing timing information of the corresponding image frame, which is the first timing information. The time stamp extraction unit 220 will transmit the first timing information to the AV synchronization control unit 218, and the AV synchronization control unit 218 will transmit the first timing information to the comparison unit 216 to store it into the register 222 inside the comparison unit 216.

As mentioned, the reference time point retrieving unit 224 of the comparison unit 216 is a counter, and when one audio sample is transmitted to the loudspeaker 214 for playing, the value of the counter will be plus one. The value of the counter represents the second timing information. That is, the second timing information is obtained by counting the audio samples. The comparator 226 will compare the first and second timing information, and transmit the comparison result to the AV synchronization control unit 218. If the value of the first timing information is less than the value of the second timing information, the AV synchronization control unit 218 then controls the video decoding unit 204 to skip decoding at least one image frame. If the value of the first timing information is greater than the value of the second timing information, the AV synchronization control unit 218 then controls the video decoding unit 204 to delay decoding at least one image frame.

The AV synchronization playback device 200 of the present invention takes the playback timing information of the audio sample which is going to be played retrieved by the reference time point retrieving unit 224 as the reference time point. Only when the value of the first timing information (i.e., the timing information of the image frame which is going to be played) is the same as the value of the second timing information, will the AV synchronization control unit 218 control the video driving unit 208 to display that image frame. Therefore, the audio sample, which is going to be played, matches the image frame, which is going to be played, to accomplish the synchronous playback of the audio-visual data.

In other words, the AV synchronization playback device 200 of the present invention utilizes the time stamp extraction unit 220 to find out the playback timing information of the next image frame that should be played (the first timing information), and stores it into the register 222 of the comparison unit 216. When the reference time point retrieving unit 224 of the comparison unit 216 counts to the value of the corresponding audio sample which should be played in synchronization with that next image frame (the second timing information), i.e., when the value of the first timing information is the same as the value of the second timing information, it is the time point for playing the next image frame that should be played. At this time point, the comparison unit 216 will send a control signal to the AV synchronization control unit 218 for controlling the video driving unit 208 to display the next image frame that should be played.

Because the AV synchronization playback device 200 of the present invention utilizes the time stamp extraction unit 220 to find out the playback timing information of the next image frame that should be played, the AV synchronization playback device 200 must decode the next image frame that should be played in advance, to make sure the real-time display of the next image frame that should be played when the reference time point retrieving unit 224 counts to the value of the corresponding audio sample. In other words, the AV synchronization playback device 200 of the present invention has a pre-processing time interval before start playing the audio-visual data. In this pre-processing time interval, the AV synchronization playback device 200 will finish the decoding of the first image frame in advance. When the reference time point retrieving unit 224 counts to the value of the corresponding first audio sample, the AV synchronization playback device 200 will synchronously play the first image frame and the first audio sample.

If the reference time point retrieving unit 224 already counts to a specific value of a particular audio sample, but the corresponding image frame is not completely decoded, the AV synchronization playback device 200 may have different means for processing/handling this situation. For example, the AV synchronization playback device 200 can be designed to still play the image frame that is not completely decoded. In this way, some noise information would exist in some portion of the displayed image. In this condition, the AV synchronization control unit 218 can make the video driving unit 208 to output the image frame that is not completely decoded.

Furthermore, the AV synchronization playback device 200 of the present invention can also be designed to play the corresponding image frame only when that image frame is completely decoded. In this situation, although synchronous playback of the audio-visual data can be achieved, some delay would occur. In this condition, the AV synchronization control unit 218 will make the video driving unit 208 to output the completely decoded image frame only when the video decoding unit 204 finishes the decoding of the corresponding image frame.

Moreover, the AV synchronization playback device 200 of the present invention can also be designed to decode more than one image frames in advance. In this condition, the AV synchronization playback device 200 will require a longer pre-processing time interval for decoding more image frames in advance, and more system resources, that is, more memory space, for storing the in advance decoded image frames.

Assume that the AV synchronization playback device 200 of the present invention is designed to decode M image frames in advance, then when the image frame needing to be displayed currently is the Nth image frame, the video decoding unit 204 will decode the (N+M)^{th} image frame, where M and N are positive integers. As mentioned above, the AV synchronization playback device 200 will need an image frame buffer (not shown) for storing the M image frames that are completely decoded in advance. Moreover, in the register 222 of the comparison unit 216, playback timing information of the M decoded image frames that are completely decoded in advance will be stored.

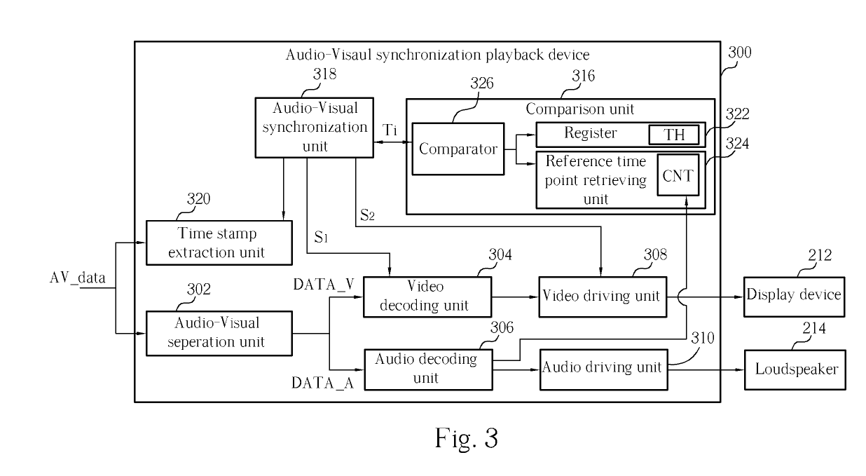

Please refer to FIG. 3. FIG. 3 is a block diagram of an AV synchronization playback device 300 according to a second embodiment of the present invention. The AV synchronization playback device 300 comprises an AV separation unit 302, a video decoding unit 304, an audio decoding unit 306, a video driving unit 308, an audio driving unit 310, a comparison unit 316, an AV synchronization control unit 318, and a time stamp extraction unit 320. The AV synchronization playback device 300 shown in FIG. 3 is similar to the AV synchronization playback device 200 shown in FIG. 2. The major difference is that the reference time point retrieving unit 324, in this embodiment, is coupled to the audio decoding unit 306 instead of the audio driving unit 310. Similarly, the reference time point retrieving unit 324 of the comparison unit 316 is a counter. In this embodiment, when one decoded audio frame is decoded and is transmitted to the audio driving unit 310, the value of the counter will be plus one. The reference time point retrieving unit 324 then can obtain the playing timing information of the decoded audio frame to be the second timing information. Similarly, the value of the counter, i.e. the reference time point retrieving unit 324, represents the second timing information. That is, the second timing information is obtained by counting the audio frames.

Similarly, the comparator 326 will compare the first and second timing information, and transmit the comparison result to the AV synchronization control unit 318. If the value of the first timing information is less than the value of the second timing information, the AV synchronization control unit 318 then controls the video decoding unit 304 to skip decoding at least one image frame. If the value of the first timing information is greater than the value of the second timing information, the AV synchronization control unit 318 then controls the video decoding unit 304 to delay decoding at least one image frame.

In this embodiment, the AV synchronization playback device 300 takes the playback timing information of the decoded audio frame as the reference time point. Similarly, the reference time point is retrieved by the reference time point retrieving unit 324. Only when the value of the first timing information (i.e., the timing information of the image frame which is going to be played) is the same as the value of the second timing information, will the AV synchronization control unit 318 control the video driving unit 308 to display that image frame. Meanwhile, the audio driving unit 310 will play the audio samples of the decoded audio frame.

In other words, when the reference time point retrieving unit 324 of the comparison unit 316 counts to the value of the corresponding audio frame which should be played in synchronization with that next image frame (the second timing information), it is the time point for playing the next image frame that should be played.

Similarly, the AV synchronization playback device 300 should decode the next image frame that should be played in advance, to make sure the real-time display of the next image frame that should be played when the reference time point retrieving unit 324 counts to the value of the corresponding audio frame. That is, the AV synchronization playback device 300 also has a pre-processing time interval before start playing the audio-visual data. In this pre-processing time interval, the AV synchronization playback device 300 will finish the decoding of the first image frame in advance. When the reference time point retrieving unit 324 counts to the value of the corresponding first audio frame, the AV synchronization playback device 300 will synchronously play the first image frame and the first audio frame.

Compared with the related art, the AV synchronization playback device of the present invention and the related method utilize the time stamp to retrieve the playback timing information of the image frame, and therefore can complete the adjustment before the occurrence of the asynchronous playback of audio and visual data, thus efficiently increasing the quality when playing an audio-visual data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A playback device for playing an audio-visual (AV) signal, the AV signal comprising a video signal portion and an audio signal portion, the playback device comprising:
a reference time point retrieving unit for retrieving playback timing information of the audio signal portion to be a reference time point; and
an AV synchronization control unit for controlling playback of the video signal portion according to the reference time point.

2. The playback device of claim 1, further comprising:
an AV separation unit for separating the AV signal into the video signal portion and the audio signal portion.

3. The playback device of claim 2, wherein the video signal portion comprises a plurality of image frames, and the playback device further comprises:
a video decoding unit coupled to the AV separation unit for decoding the image frames.

4. The playback device of claim 3, further comprising:
a video driving unit coupled to the video decoding unit for driving a monitor to display the decoded image frames sequentially.

5. The playback device of claim 2, wherein the audio signal portion comprises a plurality of audio frames, and the playback device further comprises:
an audio decoding unit coupled to the AV separation unit for decoding the audio frames.

6. The playback device of claim 5, further comprising:
an audio driving unit coupled to the audio decoding unit for sequentially receiving the decoded audio frames and sequentially outputting audio samples of the decoded audio frames to a speaker for playing;
wherein the reference time point retrieving unit is coupled to the audio driving unit and is capable of obtaining the playback timing information of the audio sample to be played in the speaker.

7. The playback device of claim 5, wherein the reference time point retrieving unit is coupled to the audio decoding unit and is capable of obtaining the playback timing information of the decoded audio frame.

8. The playback device of claim 6, wherein the video signal portion comprises a plurality of image frames, and the playback device further comprises:
a time stamp extraction unit for obtaining a time stamp for each of the image frames, wherein the time stamp is the playback timing information of a corresponding image frame.

9. The playback device of claim 8, further comprising:
a register for storing the playback timing information of the corresponding image frame.

10. The playback device of claim 9, wherein the audio signal portion comprises a plurality of audio frames, and the playback device further comprises:
a comparator coupled to the register and the reference time point retrieving unit for comparing the playback timing information of an audio sample to be played with the playback timing information of the corresponding image frame, which should be played in synchronization with that audio sample to be played, to generate at least one comparison result;
wherein the AV synchronization control unit controls the decoding or/and the playback of the video signal portion according to the comparison result.

11. The playback device of claim 1, wherein the reference time point retrieving unit is a counter.

12. The playback device of claim 7, wherein the video signal portion comprises a plurality of image frames, and the playback device further comprises:
a time stamp extraction unit for obtaining a time stamp for each of the image frames, wherein the time stamp is the playback timing information of a corresponding image frame.

13. The playback device of claim 12, further comprising:
a register for storing the playback timing information of the corresponding image frame.

14. The playback device of claim 13, wherein the audio signal portion comprises a plurality of audio frames, and the playback device further comprises:
a comparator coupled to the register and the reference time point retrieving unit for comparing the playback timing information of a decoded audio frame with the playback timing information of the corresponding image frame, which should be played in synchronization with that decoded audio frame, to generate at least one comparison result;
wherein the AV synchronization control unit controls the decoding or/and the playback of the video signal portion according to the comparison result.

15. A method for playing an audio-visual (AV) signal, the AV signal comprising a video signal portion and an audio signal portion, the method comprising:
(a) retrieving playback timing information of the audio signal portion to be a reference time point; and
(b) controlling playback of the video signal portion according to the reference time point.

16. The method of claim 15, further comprising:
separating the AV signal into the video signal portion and the audio signal portion; wherein the video signal portion comprises a plurality of image frames and the audio signal portion comprises a plurality of audio frames.

17. The method of claim 16, wherein the method further comprises:
decoding the audio frames; and
decoding the video frames.

18. The method of claim 17, further comprising:
sequentially outputting audio samples of the decoded audio frames to a speaker for playing; and
obtaining the playback timing information of the audio sample to be played in the speaker.

19. The method of claim 17, further comprising:
sequentially outputting the decoded audio frames to an audio driving unit;
obtaining the playback timing information of the decoded audio frame, which is transmitted to the audio driving unit.

20. The method of claim 18, wherein obtaining the playback timing information of the audio sample to be played in the speaker is performed by counting the audio samples of the decoded audio frames.

21. The method of claim 19, wherein obtaining the playback timing information of the decoded audio frame is performed by counting the decoded audio frames.

22. The method of claim 18, further comprising:
retrieving a time stamp for each of the image frames, wherein the time stamp is the playback timing information of a corresponding image frame.

23. The method of claim 22, further comprising:
comparing the playback timing information of an audio sample to be played with the playback timing information of the corresponding image frame, which should be played in synchronization with that audio sample to be played, to generate at least one comparison result; and
controlling the decoding and/or the playback of the video signal portion according to the comparison result.

24. The method of claim 19, further comprising:
retrieving a time stamp for each of the image frames, wherein the time stamp is the playback timing information of a corresponding image frame.

25. The method of claim 24, further comprising:
comparing the playback timing information of an decoded audio frame, which is transmitted to the audio driving unit, with the playback timing information of the corresponding image frame, which should be played in synchronization with that decoded audio frame, to generate at least one comparison result; and
controlling the decoding and/or the playback of the video signal portion according to the comparison result.

26. An integrated circuit to be embedded in a playback device for playing an audio-visual (AV) signal, the AV signal comprising a video signal portion and an audio signal portion, the playback device comprising:
a reference time point retrieving unit for retrieving playback timing information of the audio signal portion to be a reference time point; and
an AV synchronization control unit for controlling playback of the video signal portion according to the reference time point.
